(19) United States
(12) Patent Application Publication
(10) Pub. No.: US 2023/0300813 A1
(43) Pub. Date: Sep. 21, 2023

(54) BEAM INDICATION FRAMEWORK FOR SENSING-ASSISTED MIMO

(71) Applicant: HUAWEI TECHNOLOGIES CO., LTD., SHENZHEN (CN)

(72) Inventors: XIAOYAN BI, Shenzhen (CN); JIANGLEI MA, Kanata (CA); DAGENG CHEN, Kanata (CA); WEN TONG, Kanata (CA); PEIYING ZHU, Kanata (CA)

(21) Appl. No.: 18/325,506

(22) Filed: May 30, 2023

Related U.S. Application Data
(63) Continuation of application No. PCT/CN2020/139006, filed on Dec. 24, 2020.

(51) Int. Cl. H04W 72/044; H04W 72/20

(52) U.S. Cl. CPC H04W 72/046; H04W 72/20

(57) ABSTRACT

Some embodiments of the present disclosure provide beam indication solutions. A first solution relates to absolute beam indication and a second solution relates to differential beam indication. Through, for example, information determined using sensing, these beam indication solutions allow for information transfer between transmit receipt point and user equipment to occur on a relatively narrow beam. By reducing scanning, a solution based on beam indication aspects of the present application reduce overhead and, consequently, reduce latency. Another benefit of a narrow beam is improved spectral efficiency. The sensing may allow for a relationship between a beam and an external environment to be established. The relationship allows for a beam to be indicated in a direct and agile manner.

### CROSS REFERENCE

This application is a continuation of International Application No. PCT/CN2020/139006, filed on Dec. 24, 2020, the disclosure of which is hereby incorporated by reference in its entirety.

### TECHNICAL FIELD

The present disclosure relates generally to sensing-assisted MIMO and, in particular embodiments, to a beam indication framework for sensing-assisted MIMO.

### BACKGROUND

At the commencement of an initial access process, a transmit receive point (TRP) transmits synchronization signals in a beam scanning mode. A user equipment (UE) searches for the synchronization signals in a beam scanning mode. A preferred initial beam pair may be determined through such scanning. The preferred initial beam pair may be understood to include a transmitter-side beam with a transmitter-side beam direction and a corresponding receiver-side beam with a receiver-side beam direction. At the conclusion of the initial access process, indication information is often transmitted from the TRP to the UE using the transmitter-side beam.

Unfortunately, the transmitter-side beam is relatively wide and the scanning, on the part of both the TRP and the UE, causes the initial access process to be associated with overhead. One consequence of the overhead is latency.

### SUMMARY

Aspects of the present invention relate to beam management and, more particularly, to beam indication. Two beam indication solutions are disclosed. A first solution relates to absolute beam indication and a second solution relates to differential beam indication. Through, for example, information determined using sensing, these beam indication solutions allow for information transfer between TRP and UE to occur on a relatively narrow beam. By reducing scanning, a solution based on beam indication aspects of the present application reduce overhead and, consequently, reduce latency. Another benefit of a narrow beam is improved spectral efficiency. The sensing may allow for a relationship between a beam and an external environment to be established. The relationship allows for a beam to be indicated in a direct and agile manner.

According to an aspect of the present disclosure, there is provided a method. The method includes broadcasting coordinate information of the transmit receive point, the coordinate information relative to a predefined coordinate system and transmitting, to a user equipment, an indication of a beam direction of a physical channel, the indication employing the predefined coordinate system.

According to an aspect of the present disclosure, there is provided a transmit receive point. The transmit receive point includes a memory storing instructions and a processor configured, by executing the instructions, to broadcast coordinate information of the transmit receive point, the coordinate information relative to a predefined coordinate system and transmit an indication of a beam direction of a physical channel, the indication employing the predefined coordinate system.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates a sequence of rotations that relate a global coordinate system to a local coordinate system;

FIG. 6 illustrates spherical angles and spherical unit vectors;

FIG. 7 illustrates a two-dimensional planar antenna array structure of dual-polarized antenna;

FIG. 8 illustrates a two-dimensional planar antenna array structure of single polarization antenna;

FIG. 9 illustrates a grid of spatial zones, allowing for spatial zones to be indexed;

FIG. 10 illustrates, as a flow diagram, a known process for initial access;

FIG. 11 illustrates, as a flow diagram, a process for initial access according to an aspect of the present application;

FIG. 12 illustrates, as a flow diagram, a process for initial access according to an aspect of the present application;

FIG. 13 illustrates, as a flow diagram, a process for initial access according to an aspect of the present application;

FIG. 14 illustrates, as a flow diagram, a process for on-demand other system information according to an aspect of the present application;

FIG. 15 illustrates, as a flow diagram, a process for on-demand other system information according to an aspect of the present application;

FIG. 16 illustrates, as a signal flow diagram, a Msg3 based OSI request initiated access according to aspects of the present application;

FIG. 17 illustrates, as a signal flow diagram, a Msg3-based OSI request initiated access according to aspects of the present application;

FIG. 18 illustrates, as a flow diagram, a process for paging according to an aspect of the present application; and

FIG. 19 illustrates, as a flow diagram, a process for connected state data transmission according to an aspect of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

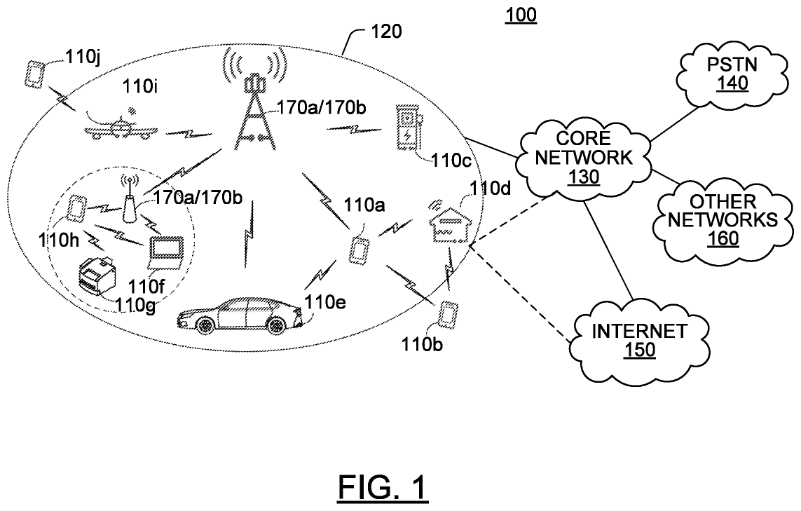

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G or 4G) radio access network. One or more communication electric device (ED) 110a, 110b, 110c, 110d, 110e, 110f, 110g, 110h 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

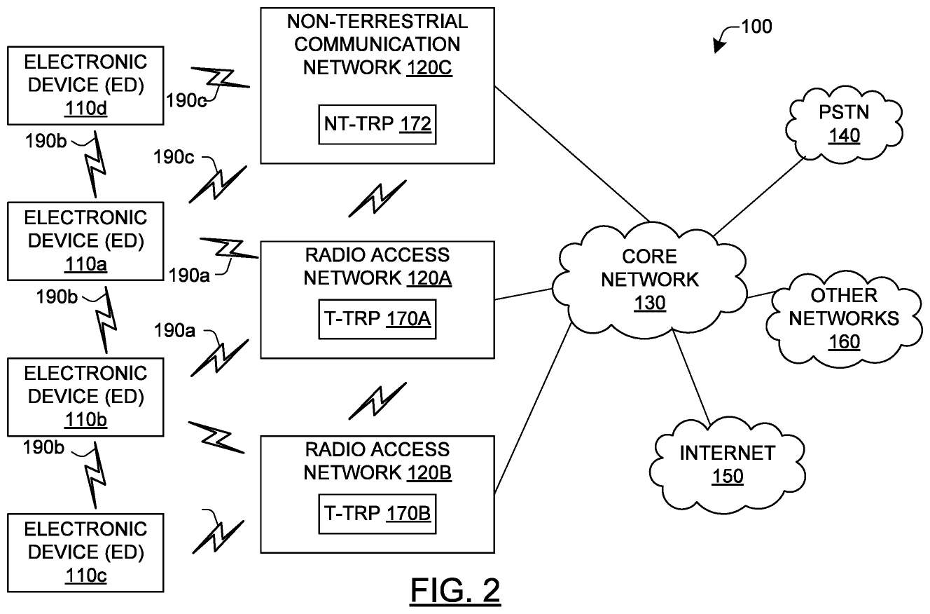

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a 110b, 110c or both, and (ii) other networks (such as the PSTN 140, the Internet 150, and the other networks 160). In addition, some or all of the EDs 110a 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

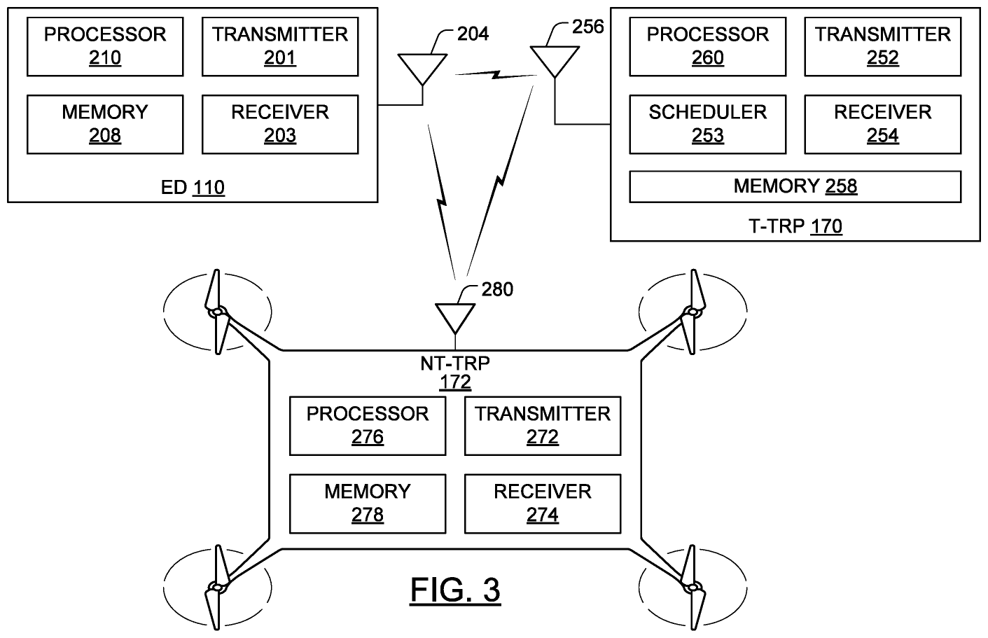

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random-access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

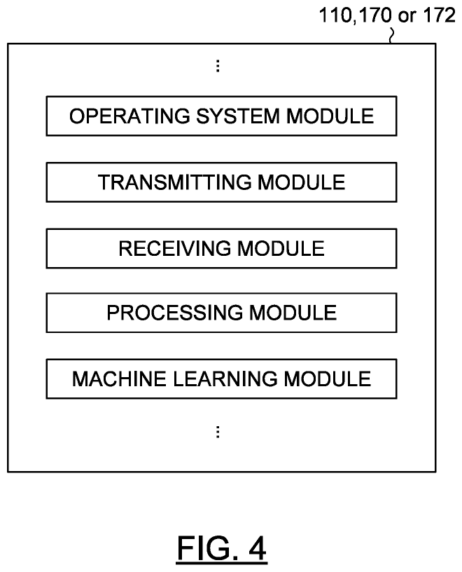

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA).

Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device, wherein the device can be a UE or a TRP, can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

The carrier, the BWP or the occupied bandwidth may be signaled by a network device (e.g., by a base station 170) dynamically, e.g., in physical layer control signaling such as in the known downlink control information (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

Going to the future wireless network, the number of the new devices could be increased exponentially with diverse functionalities. Also, a lot more new applications and use cases than those associated with 5G may emerge with more diverse quality of service demands. These use cases will result in new key performance indications (KPIs) for the future wireless networks (for an example, 6G network) that can be extremely challenging. It follows that sensing technologies and artificial intelligence (AI) technologies, especially machine learning (ML) and deep learning technologies, are being introduced to telecommunication for improving the system performance and efficiency.

AI/ML technologies may be applied to communication systems. In particular AI/ML technologies may be applied to communication in Physical layer and to communication in media access control (MAC) layer.

For the physical layer, the AI/ML technologies may be employed to optimize component design and improve algorithm performance. For example, AI/ML technologies may be applied to channel coding, channel modelling, channel estimation, channel decoding, modulation, demodulation, MIMO, waveform, multiple access, PHY element parameter optimization and update, beam forming and tracking and sensing and positioning, etc.

For the MAC layer, AI/ML technologies may be utilized in the context of learning, predicting and making decisions to solve complicated optimization problems with better strategy and optimal solution. For one example, AI/ML technologies may be utilized to optimize the functionality in MAC for, e.g., intelligent TRP management, intelligent beam management, intelligent channel resource allocation, intelligent power control, intelligent spectrum utilization, intelligent modulation and coding scheme selection, intelligent HARQ strategy, intelligent transmit/receive mode adaption, etc.

AI/ML architectures usually involve multiple nodes. The multiple nodes can be organized in two modes, i.e., a centralized mode and a distributed mode, both of which modes can be deployed in an access network, a core network or an edge computing system or third network. A centralized training and computing architecture is restricted by communication overhead and strict user data privacy. Distributed training and computing architecture may be organized according to several frameworks, e.g., distributed machine learning and federated learning. AI/ML architectures include an intelligent controller, which can perform as a single agent or as a multi-agent, based on joint optimization or individual optimization. New protocols and signaling mechanisms may be established so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, tracking, autonomous delivery and mobility. Terrestrial network-based sensing and non-terrestrial network-based sensing could provide intelligent context-aware networks to enhance the UE experience. For an example, terrestrial network-based sensing and non-terrestrial network-based sensing may be shown to provide opportunities for localization applications and sensing applications based on new sets of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial networks and in non-terrestrial networks, the measured channel data and sensing and positioning data can be obtained by large bandwidth, new spectrum, dense network and more light-of-sight (LOS) links. Based on these data, a radio environmental map can be drawn through AI/ML methods, where channel information is linked, in the map, to its corresponding positioning, or environmental information, to, thereby, provide an enhanced physical layer design based on this map.

Sensing coordinators are nodes in a network that can assist in the sensing operation. These nodes can be stand-alone nodes dedicated to just sensing operations or other nodes (for example, the T-TRP 170, the ED 110, or a node in the core network 130) doing the sensing operations in parallel with communication transmissions. New protocol and signaling mechanism is needed so that the corresponding interface link can be performed with customized parameters to meet particular requirements while minimizing signaling overhead and maximizing the whole system spectrum efficiency.

AI/ML and sensing methods are data hungry. In order to involve AI/ML and sensing in wireless communications, more and more data are needed to be collected, stored and exchanged. The characteristics of wireless data are known to expand to large ranges in multiple dimensions, e.g., from sub-6 GHz, millimeter to Terahertz carrier frequency, from space, outdoor to indoor scenario, and from text, voice to video. These data are collecting, processing and usage are performed in a unified framework or a different framework.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high-altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible units or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted by or received by at least one antenna port. A beam may be formed by using another method, for example, adjusting a related parameter of an antenna unit. A reference to a given beam may be a reference to a transmit beam or a reference to a receive beam. Transmit beam information may indicate a distribution of signal strength formed in different directions in space after a signal is transmitted through an antenna. Receive beam information may indicate a distribution of signal strength for a wireless signal received from an antenna and that is in different directions in space. Beam information may include a beam identifier, an antenna port(s) identifier, a channel state information reference signal (CSI-RS) resource identifier, an SSB resource identifier, a sounding reference signal (SRS) resource identifier, or other reference signal resource identifier. A transmit beam may be implemented using a transmit spatial filter. Similarly, a receive beam may be implemented using a receive spatial filter.

6G is expected to integrate sensing and communication capabilities for a win-win cooperation. Empowered by artificial intelligence, 6G Network nodes and UEs will cooperate to bring powerful sensing capabilities to 6G and make 6G network equipment aware of its surrounding and situation. Situation awareness (SA) is an emerging communication paradigm where the network equipment makes proactive decisions based on the knowledge of propagation environment, user traffic pattern, user mobility behavior, weather conditions, etc. If the network equipment can determine the location, orientation, size and fabric of the main clutter interacting with the electromagnetic wave in the environment, the network equipment can deduce a more accurate picture of the channel condition, such as reliable beam directions, attenuation and propagation loss, interference level, interference sources and shadow fading to enhance network capacity and robustness. For example, the knowledge of the RF map can be used to perform beam management and CSI acquisition with significantly lower resource and power overhead by purposeful MIMO subspace selection and thus avoiding aimless and exhaustive beam sweeping. It facilitates interference management and avoidance and handover by predicting the beam failures, shadowing and mobility.

As one of key technologies of known NR cellular systems, MIMO can improve a system capacity by using more spatial degrees of freedom. It is often considered that MIMO is bound to become one of key technologies of 6G wireless networks.

6G MIMO is expected to utilize and rely on an increased number of antenna elements for transmission and reception, which makes 6G air interface predominantly beam-based. To guarantee the success of MIMO technologies in achieving the goals of 6G networks, its design should follow some principles to ensure a reliable, agile, proactive and low overhead beam management.

Beam management is one of the elements of successful use of MIMO. A proactive beam management mechanism detects and predicts beam failure and mitigates beam failure. Such mechanism should facilitate agile beam recovery and autonomously track, refine and adjust beams. To achieve these goals, Intelligent and data-driven beam selection assisted by sensing and localization information gathered through air interface or other sensors should be supported by 6G to enable “handover-free” mobility through user centric beams.

In typical beam management schemes, a weight of an antenna (port), in a multi-antenna system, may be adjusted so that energy in the transmitted signals is directional. That is, the energy is aggregated in a certain direction. Such an aggregation of energy is typically called a beam. For NR, the entire air interface is designed based on beams; uplink channels are transmitted on beams; and downlink channels are received on beams. Beam management relates to establishing and retaining a suitable beam pair. A beam pair includes a transmitter-side beam direction and a corresponding receiver-side beam direction. When implemented appropriately, a beam pair jointly provides good connectivity. Aspects of beam management include initial beam establishment, beam adjustment and beam recovery.

Beam management may include transmitting a so-called beam indication. A beam indication may be used, by a TRP 170, to indicate, to a UE 110, a specific beam on which to receive a particular channel. In NR, the TRP 170 may use an SSB index (also called an SSB resource identifier) and a physical random-access channel (PRACH) transmission moment to indicate a specific beam in an initial access phase. After a radio resource control (RRC) connection has been established, the TRP 170 may use a Transmission Configuration Indicator State (TCI-State) to indicate beam information. The TCI-State associates one or two DL reference signals (e.g., SSB, CSI-RS, etc.) with a corresponding quasi-colocation (QCL) type. The term “QCL” relates to a relationship between two antenna ports. In a case wherein a first antenna port is related to a second antenna port by QCL, it is understood that channel features obtained from the first antenna port can be used for the second antenna port, thereby indicating a beam to the UE 110. QCL-based beam indication may be shown to depend on beam pre-training and/or measurement. It follows, then, that QCL-based beam indication has a disadvantage of large overhead and large latency.

In NR, the known beam management strategy may be considered to be a passive beam management strategy. With the increasing number of UEs 110 in future wireless communication network, the overhead associated with QCL-based beam indication may be expected to increase sharply. The primary cause of the overhead may be due to an increase in a quantity of pre-training beams and/or measurement beams. In addition, future networks are expected to demand reduced latency.

The rapid development of sensing technology is expected to provide devices in future networks with detailed awareness of the environment in which the devices are operating. By processing received sensing signals that have echoed off a given UE 110, a TRP 170 may determine a location for the given UE 110.

In overview, aspects of the present application relate to coordinate-based beam indication. On the basis of location information, for the given UE 110, obtained, by the TRP 170, through the use of sensing signals, the TRP 170 may provide a coordinate-based beam indication to the given UE 110. A coordinate system for use in such a coordinate-based beam indication may be predefined. In view of the predefined coordinate system, the TRP 170 may broadcast location coordinates of the TRP 170. The TRP 170 may also use the coordinate system to indicate, to the given UE 110, a beam direction, e.g., for a physical channel. Some aspects of the present application relate to beam management using an absolute beam indication, while other aspects of the present application relate to a differential beam indication.

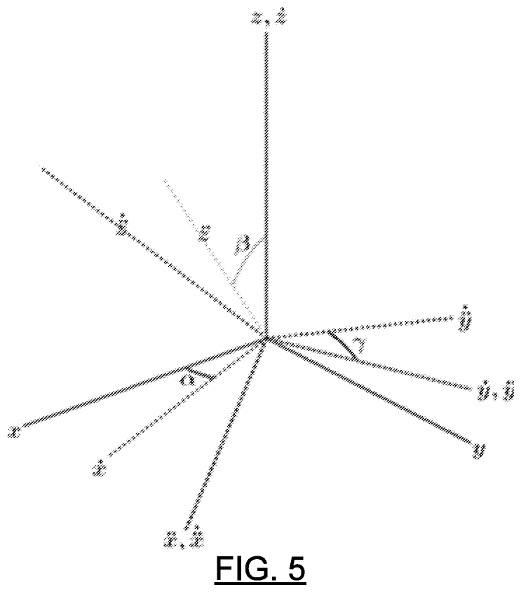

Initially, a global coordinate system (GCS) and multiple local coordinate systems (LCS) may be defined. The GCS may be a global unified geographical coordinate system or a coordinate system comprising of only some TRPs 170 and UEs 110, defined by the RAN. From another perspective, GCS may be UE-specific or common to a group of UEs. An antenna array for a TRP 170 or a UE 110 can be defined in a Local Coordinate System (LCS). An LCS is used as a reference to define the vector far-field that is pattern and polarization, of each antenna element in an array. The placement of an antenna array within the GCS is defined by the translation between the GCS and an LCS. The orientation of the antenna array with respect to the GCS is defined in general by a sequence of rotations. The sequence of rotations may be represented by the set of angles α, β and γ. The set of angles {α, β, γ} can also be termed as the orientation of the antenna array with respect to the GCS. The angle α is called the bearing angle, β is called the downtilt angle and γ is called the slant angle. FIG. 5 illustrates the sequence of rotations that relate the GCS and the LCS. In FIG. 5, an arbitrary 3D-rotation of the LCS is contemplated with respect to the GCS given by the set of angles {α, β, γ}. The set of angles {α, β, γ} can also be termed as the orientation of the antenna array with respect to the GCS. Any arbitrary 3-D rotation can be specified by at most three elemental rotations and, following the framework of FIG. 5, a series of rotations about the z, \dot{y} and \ddot{x} axes are assumed here, in that order. The dotted and double-dotted marks indicate that the rotations are intrinsic, which means that they are the result of one (\dot{ }) or two (\ddot{ }) intermediate rotations. In other words, the \dot{y} axis is the original y axis after the first rotation about the z axis and the \ddot{x} axis is the original x axis after a first rotation about the z axis and a second rotation about the \dot{y} axis. A first rotation of a about the z axis sets the antenna bearing angle (i.e., the sector pointing direction for a TRP antenna element). The second rotation of β about the \dot{y} axis sets the antenna downtilt angle.

Finally, the third rotation of y about the x axis sets the antenna slant angle. The orientation of the x, y and z axes after all three rotations can be denoted as [symbol] , [symbol] , and [symbol] . These triple-dotted axes represent the final orientation of the LCS and, for notational purposes, may be denoted as the x′, y′ and z′ axes (local or “primed” coordinate system).

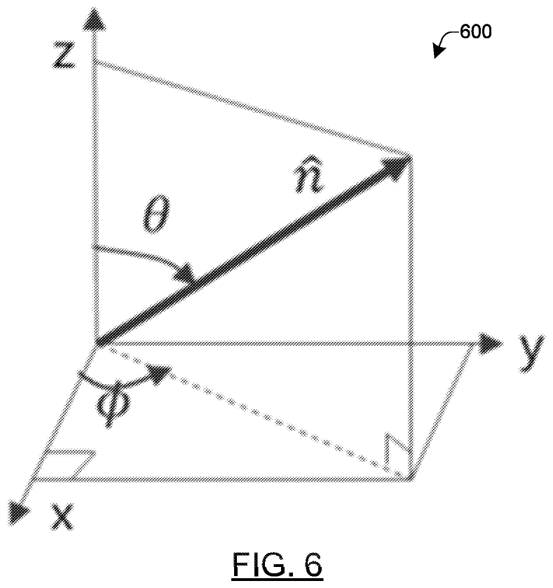

A coordinate system is defined by the x, y and z axes, the spherical angles and the spherical unit vectors as illustrated in FIG. 6. A representation 600 in FIG. 6 defines a zenith angle θ and the azimuth angle θ in a Cartesian coordinate system. \hat{n} is the given direction and the zenith angle, θ, and the azimuth angle, ϕ, may be used as the relative physical angle of the given direction. Note that θ=0 points to the zenith and ϕ=0 points to the horizon.

A method of converting the spherical angles (θ,ϕ) of the GCS into the spherical angles (θ′, ϕ′) of the LCS according to the rotation operation defined by the angles α, β and γ is given below.

To establish the equations for transformation of the coordinate system between the GCS and the LCS, a composite rotation matrix is determined that describes the transformation of point (x,y,z), in the GCS, into point (x′,y′,z′), in the LCS. This rotation matrix is computed as the product of three elemental rotation matrices. The matrix to describe rotations about the z, \dot{y} and \ddot{x} axes by the angles α, β and γ, respectively and in that order is defined in equation (1), as follows:

$$\begin{matrix}R = {R}_{Z} ( α ) {R}_{Y} ( β ) {R}_{X} ( γ ) \\ = ( \begin{matrix}+ cos α & - s in α & 0 \\ + s in α & + cos α & 0 \\ 0 & 0 & 1\end{matrix} ) ( \begin{matrix}+ cos β & 0 & + s in β \\ 0 & 1 & 0 \\ - sin β & 0 & + cos β\end{matrix} ) ( \begin{matrix}1 & 0 & 0 \\ 0 & + cos γ & - s in γ \\ 0 & + s in γ & + cos γ\end{matrix} )\end{matrix} \qquad ( 1 )$$

The reverse transformation is given by the inverse of R. The inverse of R is equal to the transpose of R, since R is orthogonal.

R⁻¹=R_{X}(−γ)R_{Y}(−β)R_{Z}(−α)=R^{T} (2)

The simplified forward and reverse composite rotation matrices are given in equations (3) and (4).

$$R = ( \begin{matrix}cos αcos β & cos αsinβsinγ - sin αcosγ & cos αsinβcosγ + sin αsinγ \\ sin αcosβ & sin αsinβsinγ + cos αcosγ & sin αsinβcosγ - cos αsinγ \\ - s in β & cos βsinγ & cos βcosγ\end{matrix} ) \qquad ( 3 )$$

$${R}^{- 1} = ( \begin{matrix}cos αcosβ & sin αcosβ & - s in β \\ cos αsinβsinγ - sin αcosγ & sin αsinβsinγ + cos αcosγ & cos βsinγ \\ cos αsinβcosγ + sin αsinγ & sin αsinβcosγ - cos αsinγ & cos βcosγ\end{matrix} ) \qquad ( 4 )$$

These transformations can be used to derive the angular and polarization relationships between the two coordinate systems.

In order to establish the angular relationships, consider a point (x, y, z) on the unit sphere defined by the spherical coordinates (ρ=1,θ,ϕ), where ρ is the unit radius, θ is the zenith angle measured from the +z-axis and ϕ is the azimuth angle measured from the +x-axis in the x-y plane. The Cartesian representation of that point is given by

$$\hat{ρ} = ( \begin{matrix}x \\ y \\ z\end{matrix} ) = ( \begin{matrix}sin θ cos φ \\ sin θ sin φ \\ cos θ\end{matrix} ) \qquad ( 5 )$$

The zenith angle is computed as arccos(\hat{ρ}·\hat{z}) and the azimuth angle as arg(\hat{x}·\hat{ρ}+j ŷ·\hat{ρ}), where \hat{x}, ŷ and \hat{z} are the Cartesian unit vectors. If this point represents a location in the GCS defined by θ and ϕ, the corresponding position in the LCS is given by R⁻¹\hat{ρ}, from which local angles θ′ and ϕ′ can be computed. The results are given in equations (6) and (7)

$${θ}^{′} ( α , β , γ ; θ , φ ) = {cos}^{- 1} ( {[ \begin{matrix}0 \\ 0 \\ 1\end{matrix} ]}^{T} {R}^{- 1} \hat{ρ} ) = {cos}^{- 1} ( cos β cos γ cos α + ( sin β cos γcos ( φ - α ) - sin γsin ( φ - α ) ) sin θ ) \qquad ( 6 )$$

$${ϕ}^{′} ( α , β , γ ; θ , φ ) = arg ( {[ \begin{matrix}1 \\ j \\ 0\end{matrix} ]}^{T} {R}^{- 1} \hat{ρ} ) = arg ( \begin{matrix}( cos βsinθcos ( φ - α ) - sin βcosθ ) + \\ j ( cos βsinγcosθ + ( sin βsinγcos ( φ - α ) + cos γ sin ( φ - α ) ) sin θ )\end{matrix} ) \qquad ( 7 )$$

A beam link between the TRP 170 and the given UE 110 may be defined using various parameters. In the context of the local coordinate system, having the TRP 170 at the origin, the parameters may be defined to include a relative physical angle and an orientation between the TRP 170 and the given UE 110. The relative physical angle, or beam direction “ξ,” may be used as one or two of the coordinates for the beam indication. The TRP 170 may use conventional sensing signals to obtain the beam direction, ξ, to associate with the given UE 110.

If the coordinate system is defined by the x, y and z axes, the location “(x, y, z),” of the TRP 170 or the UE 110, may be used as one or two or three of the coordinates for beam indication. The location “(x, y, z)” may be obtained through the use of sensing signals.

The beam direction may contain a value representative of a zenith of an angle of arrival, a value representative of a zenith of an angle of departure, a value representative of an azimuth of an angle of arrival or an azimuth of an angle of departure.

A boresight orientation may be used as one or two of the coordinates for the beam indication. Additionally, a width may be used as one or two of the coordinates for the beam indication.

Location information and orientation information for the TRP 170 may be broadcast to all UEs 110 in communication of the TRP 170. In particular, the location information for the TRP 170 may be included in the known System Information Block 1 (SIB1). Alternatively, the location information for the TRP 170 may be included as part of a configuration of the given UE 110.

According to the absolute beam indication aspects of the present application, when providing a beam indication to the given UE 110, the TRP may indicate the beam direction, ξ, as defined in the local coordinate system.

In contrast, according to the differential beam indication aspects of the present application, when providing a beam indication to the given UE 110, the TRP may indicate the beam direction using differential coordinates, Δξ, relative to a reference beam direction. Of course, this approach relies on both the TRP 170 and the given UE 110 having been configured with the reference beam direction.

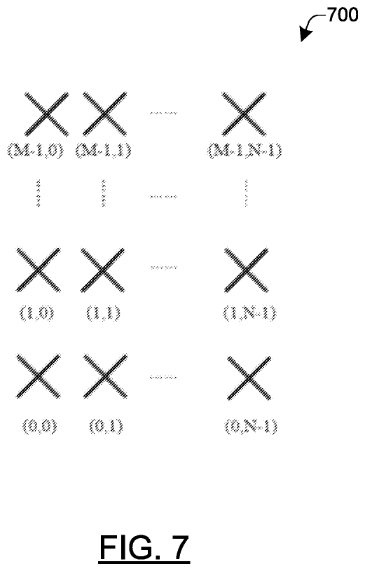

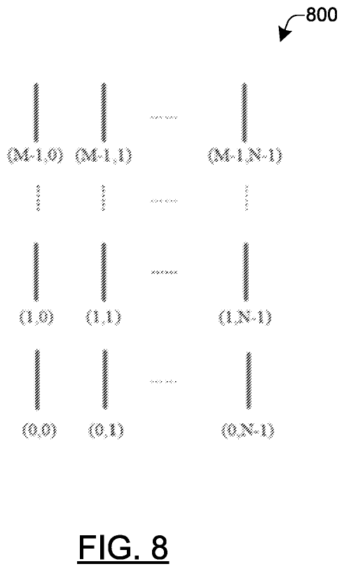

The beam direction could also be defined according to predefined spatial grids. FIG. 7 illustrates a two-dimensional planar antenna array structure 700 of a dual polarized antenna. FIG. 8 illustrates a two-dimensional planar antenna array structure 800 of a single polarized antenna. Antenna elements may be placed in vertical and horizontal directions as illustrated in FIGS. 7 and 8, where N is the number of columns and M is the number of antenna elements with the same polarization in each column. The radio channel between the TRP 170 and the UE 110 may be segmented into multiple zones. Alternatively, the physical space between the TRP 170 and the UE 110 may be segmented into 3D zones, wherein multiple spatial zones include the zones in vertical and horizontal directions.

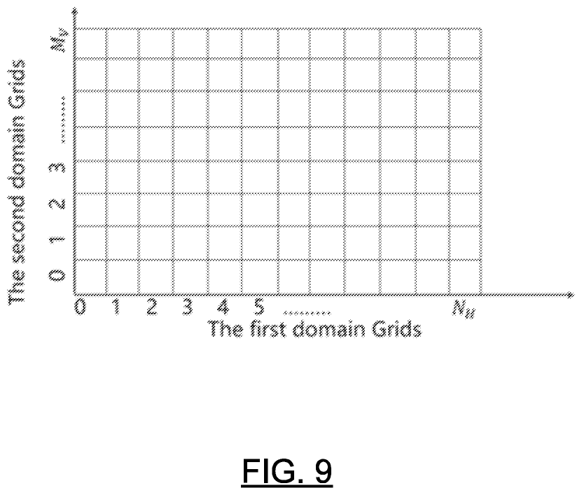

With reference to a grid 900 of spatial zones illustrated in FIG. 9, a beam indication may be an index of a spatial zone, for example, the index of the grids. Here N_{H} can be same or different as the N of the antenna array, M_{V} could be same or different as the M of the antenna array. For an X-pol antenna array, the beam direction of the two-polarization antenna array can be indicated independently or by a single indication. Each of the grid is corresponding to a vector in column and a vector in row, which are generated by partial or full of the antenna array. Such beam indication in spatial domain may be indicated by the combination of a spatial domain beam and a frequency domain vector. Further, beam indication may be a one-dimensional index of the spatial zone (X-pol antenna array or Y-pol antenna array). In addition, a beam indication may be the three-dimension index of the spatial zone (X-pol antenna array and Y-pol antenna array and Z-pol antenna array).

Initial access is a process by which a UE 110 establishes a radio link with a TRP 170. Data transmission between the TRP 170 and the UE 110 can be performed only after the initial access process is complete.

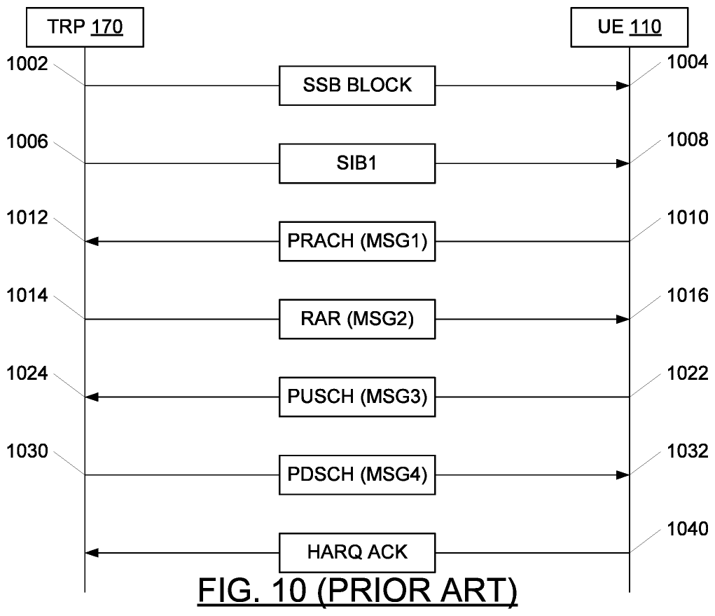

In the known (NR) version of initial access, illustrated as a flow diagram in FIG. 10, the TRP 170 transmits (step 1002) a synchronization signal and physical broadcast channel block (a SS/PBCH block) in a beam scanning mode. A SS/PBCH block is also known as an SSB block. The SSB block generally includes a primary synchronization signal (PSS), a secondary synchronization signal (SSS) and a PBCH.

The UE 110 searches for a PSS/SSS in a beam scanning mode. A preferred initial SSB beam pair may be determined through such scanning. An SSB beam pair includes a transmitter-side beam direction and a corresponding receiver-side beam direction. Upon receiving (step 1004) the SSB block, the UE 110 uses the PSS/SSS to achieve frame synchronization and timeslot synchronization. The UE 110 also uses the PSS/SSS to obtain a physical cell ID associated with the TRP 170. The UE 110 may demodulate the PBCH to obtain a master information block (MIB), an SSB block index, complete time domain information, etc.

After obtaining the SSB block index and other information, the UE 110 cannot yet camp on the cell and initiate random access. To camp on the cell and initiate random access, the UE 110 also obtains mandatory system information, namely, RMSI. The RMSI is transmitted (step 1006), by the TRP 170, in a SIB1 over the PDSCH. The UE 110 obtains PDCCH configuration information of SIB1 from the MIB demodulated from the SSB block received in step 1004. The UE 110 performs blind detection on the PDCCH to obtain the DCI. The DCI provides the UE 110 with the physical layer resource allocation that allows the UE 110 to anticipate the scheduled receipt (step 1008) of the PDSCH SIB1.

The UE 110 may then initiate random access. At an appropriate RACH occasion, the UE 110 transmits (step 1010), to the TRP 170 using so-called “Msg1,” a PRACH preamble scrambled using a random-access radio network temporary identifier (RA-RNTI). The appropriate RACH occasion may be defined as assigned time-frequency resources obtained from the SSB block received in step 1004.

Upon receiving (step 1012) the PRACH preamble, the TRP 170 may determine a preferred transmit SSB beam index that can provide suitable connectivity.

The TRP 170 may then transmit a random-access response (RAR) on the beam corresponding to the preferred transmit SSB beam index. The RAR is also called “Msg2.”

During a so-called RAR period window, the UE uses 110 the RA-RNTI to monitor the PDCCH. The UE 110 then receives (step 1016) the RAR carried on the PDSCH. The UE 110 may obtain uplink synchronization based on a time alignment (TA) value found in the RAR message. The UE 110 may also find a temporary cell RNTI (TC-RNTI) in the RAR message.

The UE 110 transmits (step 1022) “Msg3” on the PUSCH using uplink resources allocated. Msg3 may carry an RRC Connection Request message or an RRC Connection Re-establishment Request message. An indication of a UE Contention Resolution Identity is also carried by Msg3 for contention resolution.

The TRP 170 receives (step 1024) and attempts to decode a PUCCH scrambled by the TC-RNTI or a cell RNTI (C-RNTI). If the decoding of PUCCH succeeds, contention resolution and random access are considered to be successful and the TRP 170 allocates a unique C-RNTI to the UE 110.

The TRP 170 transmits (step 1030), to the UE 110 in “Msg4,” a UE Contention Identity message to, thereby, complete the contention resolution process. The TRP 170 conventionally uses an SSB beam to transmit (step 1030) Msg4. Upon receiving (step 1032), and successfully decoding, Msg4, the UE 110 transmits (step 1040) a HARQ ACK message. The HARQ ACK message is a response to the Msg4 received in step 1032. It is known that only the UE 110 that successfully completes contention resolution sends the HARQ ACK message.

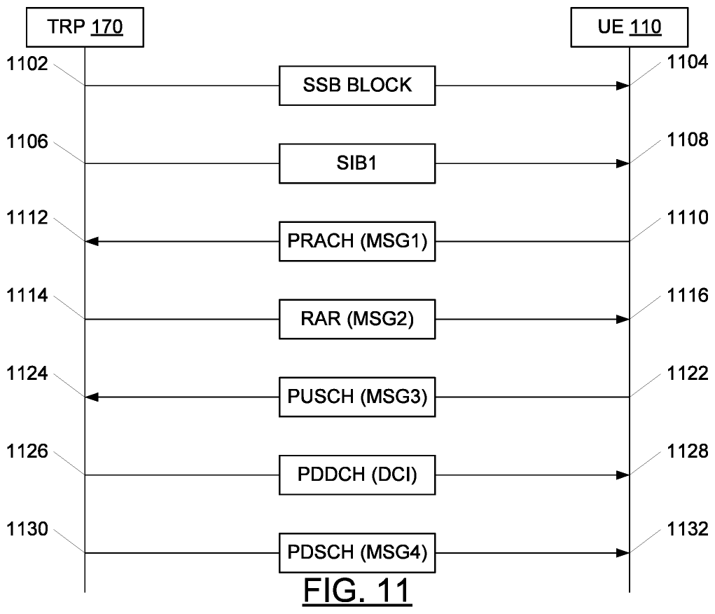

In aspects of the present application, before an initial access phase, which is illustrated as a flow diagram in FIG. 11, may commence, a coordinate system may be predefined. The predefined coordinate system includes multiple local coordinate systems. The TRP 170 is used as the origin in each local coordinate system.

In operation, for initial access in aspects of the present application, a coordinate-based beam indication may be carried by Msg4 and a corresponding reference beam direction may be carried by Msg2.

In the flow diagram of FIG. 11, the TRP 170 transmits (step 1102) an SSB block in a beam scanning mode.

The UE 110 searches for a PSS/SSS in a beam scanning mode. A preferred initial SSB beam pair may be determined through such scanning. An SSB beam pair includes a transmitter-side beam direction and a corresponding receiver-side beam direction. Upon receiving (step 1104) the SSB block, the UE 110 uses the PSS/SSS to achieve frame synchronization and timeslot synchronization. The UE 110 also uses the PSS/SSS to obtain a physical cell ID associated with the TRP 170. The UE 110 may demodulate the PBCH to obtain a master information block (MIB), an SSB block index, complete time domain information, etc.

After obtaining the SSB block index and other information, the UE 110 cannot yet camp on the cell and initiate random access. To camp on the cell and initiate random access, the UE 110 also obtains mandatory system information, namely, RMSI. The RMSI is transmitted (step 1106), by the TRP 170, in a SIB1 over the PDSCH. The UE 110 obtains PDCCH configuration information of SIB1 from the MIB demodulated from the SSB block received in step 1104. The UE 110 performs blind detection on the PDCCH to obtain the DCI. The DCI provides the UE 110 with the physical layer resource allocation that allows the UE 110 to anticipate the scheduled receipt (step 1108) of the PDSCH SIB1.

According to aspects of the present application, the TRP 170 includes, in the SIB1, coordinate information of the TRP 170. It follows that the UE 110 may obtain coordinate information of the TRP 170 from the SIB1.

The UE 110 may then initiate random access. At an appropriate RACH occasion, the UE 110 transmits (step 1110), to the TRP 170 using so-called Msg1, a PRACH preamble scrambled using a RA-RNTI. The appropriate RACH occasion may be defined as assigned time-frequency resources obtained from the SSB block received in step 1104.

Upon receiving (step 1112) the PRACH preamble, the TRP 170 may determine a preferred transmit SSB beam index that can provide suitable connectivity.

The TRP 170 may then transmit (step 1114) a RAR on the beam corresponding to the preferred transmit SSB beam index. The RAR is also called Msg2.

Since the transmit SSB beam that is preferred by the TRP 170 has been determined, coordinate-based beam indications may begin to be established. The direction of the TRP transmit SSB beam may be used as a reference direction and beam indication may be performed in a coordinate-based differential indication manner. Msg2 may include an indication of the TRP transmit SSB beam as reference transmit beam and the reference direction may be absolute. An absolute reference direction may be expressed in the predefined coordinate system.

During the RAR period window, the UE 110 uses the RA-RNTI to monitor the PDCCH. The UE 110 then receives (step 1116) the RAR carried on the PDSCH. The UE 110 may obtain uplink synchronization based on a TA adjustment value found in the RAR message. The UE 110 may also find a TC-RNTI in the RAR message.

The UE 110 transmits (step 1122) Msg3 on the PUSCH using uplink resources allocated, to the UE 110, by the TRP 170. Msg3 may carry an RRC Connection Request message or an RRC Connection Re-establishment Request message. An indication of a UE Contention Resolution Identity is also carried by Msg3 for contention resolution.

The TRP 170 receives (step 1124) the PUCCH and attempts to decode the PUCCH scrambled by the TC-RNTI or a cell RNTI (C-RNTI). If the decoding of PUCCH succeeds, contention resolution and random access are considered to be successful and the TRP 170 allocates a unique C-RNTI to the UE 110.

According to aspects of the present application, the TRP 170 transmits (step 1126), to the UE 110 in the DCI portion of a PDCCH, an indication of a beam direction for a to-be-transmitted PDSCH, expressed in the predefined coordinate system. The indication of the PDSCH beam direction may be represented by differential coordinates. Upon receipt (step 1128) of the DCI, the UE 110 may be considered to have been provided with the physical layer resource allocation that allows the UE 110 to anticipate the scheduled receipt (step 1132) of the to-be-transmitted PDSCH.

Subsequent to transmitting (step 1126) the DCI including the indication of the PDSCH beam direction, the TRP 170 may use the provided PDSCH beam direction to transmit (step 1130) Msg4 to the UE 110. In contrast to the wide SSB beam conventionally used to transmit (step 1030, FIG. 10) Msg4 to the UE 110, aspects of the present application allow the transmission (step 1130) of Msg4 to the UE 110 to occur on the PDSCH channel using a narrow beam.

The TRP 170 may include, in Msg4 in the PDSCH transmitted in step 1130, a UE Contention Identity message to, thereby, complete the contention resolution process. Upon receiving (step 1132), and successfully decoding, Msg4, the UE 110 transmits, to the TRP 170, a HARQ ACK message (not shown).

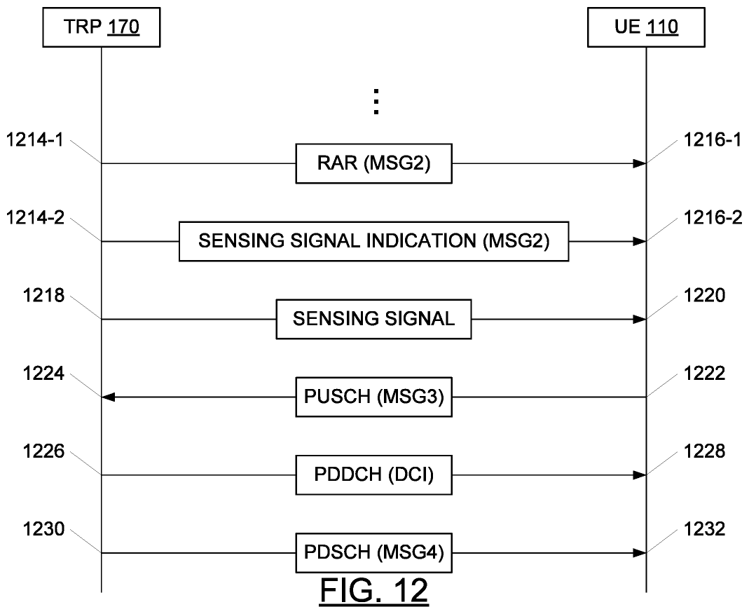

An alternative to the initial access phase of FIG. 11 is illustrated as a flow diagram in FIG. 12. In common with the initial access phase of FIG. 11, the initial access phase of FIG. 12 relies upon predefinition of a coordinate system. The predefined coordinate system includes multiple local coordinate systems. The TRP 170 is used as the origin in each local coordinate system.

FIG. 12 differs from FIG. 11 in the use of a coordinate-based beam indication for transmitting a downlink sensing signal.

In the context of the initial access phase flow diagram of FIG. 12, configuration of one or more sensing signals may be predefined. In the case of a single, predefined sensing signal, such a sensing signal may be called a default sensing signal. Alternatively, in the case wherein there are multiple sensing signals predefined, it will be shown that the UE 110 receives an indication of one configuration from among the multiple predefined configurations. Each configuration may relate to such sensing signal features as time resource, frequency resource, position, bandwidth, beam direction, beam index, scan mode, beam indication and beam indication manner.

The flow diagram of FIG. 12 begins after the UE 110 has initiated random access by transmitting (step 1110), to the TRP 170 using so-called Msg1, a PRACH preamble scrambled using a RA-RNTI. Upon receiving (step 1112) the PRACH preamble, the TRP 170 may determine a preferred transmit SSB beam index that can provide suitable connectivity.

The TRP 170 may then transmit (step 1214-1) a RAR on the beam corresponding to the preferred transmit SSB beam index. The RAR is also called Msg2.

Since the transmit SSB beam that is preferred by the TRP 170 has been determined, coordinate-based beam indications may begin to be established. The direction of the TRP transmit SSB beam may be used as a reference direction and beam indication may be performed in a coordinate-based differential indication manner. Msg2 may include an indication of the TRP transmit SSB beam as reference transmit beam and the reference direction may be absolute. An absolute reference direction may be expressed in the predefined coordinate system.

The TRP 170 may use the DCI portion of Msg2 to transmit (step 1214-2) an indication of a particular to-be-transmitted downlink sensing signal. Conveniently, the to-be-transmitted downlink sensing signal may be configured to be narrower than the TRP transmit SSB beam.

The to-be-transmitted downlink sensing signal may be selected, by the TRP 170, from among the predefined sensing signals. The TRP 170 may indicate (step 1214-2), to the UE 110, the selected to-be-transmitted downlink sensing signal by reference to a beam index.

As an alternative to indicating (step 1214-2), to the UE 110, the selected to-be-transmitted downlink sensing signal by reference to a beam index, the TRP 170 may indicate (step 1214-2), to the UE 110, a to-be-transmitted downlink sensing signal using a coordinate-based differential beam indication. The coordinate-based differential beam indication may be based on the reference direction of the TRP transmit SSB beam used to transmit (step 1214-1) Msg2.

As a further alternative to indicating (step 1214-2), to the UE 110, the selected to-be-transmitted downlink sensing signal by reference to a beam index, the TRP 170 may indicate (step 1214-2), to the UE 110, a to-be-transmitted downlink sensing signal using a coordinate-based absolute beam direction indication.

In the foregoing, the to-be-transmitted downlink sensing signal has been referenced as a single signal. Instead, the sensing signal may be a plurality of sensing signals, to be transmitted, by the TRP 170 to the UE 110, in a scanning manner.

Accordingly, when the TRP 170 indicates (step 1214-2), to the UE 110, a to-be-transmitted downlink sensing signal, the TRP 170 may indicate (step 1214-2) a plurality (say, M) of configurations for to-be-transmitted downlink sensing signals.

In one aspect, the TRP 170 may indicate (step 1214-2) all M configurations by beam index or by coordinate. In another aspect, the TRP 170 may indicate (step 1214-2) a subset of the M configurations, by beam index or by coordinate, where the subset represents the beam configurations that will not be transmitted. In a further aspect, the TRP 170 may indicate (step 1214-2) an interval or a range using the predefined coordinate system.

During the RAR period window, the UE 110 uses the RA-RNTI to monitor the PDCCH. The UE 110 then receives (steps 716-1 and 716-2) the RAR carried on the PDSCH. The UE 110 may obtain uplink synchronization based on a TA adjustment value found in the RAR message. The UE 110 may also find a TC-RNTI in the RAR message.

Subsequent to the UE 110 having received (step 1216-2) indications of the configuration(s) of the to-be-transmitted downlink sensing signal(s), the TRP 170 transmits (step 1218) the downlink sensing signals according to the configurations. To improve sensing precision, the sensing signals may be configured with beams that are narrower than the TRP transmit SSB beam. The UE 110 may use a scanning approach to the task of receiving (step 1220) the downlink sensing signals. Through such use of the scanning approach, the UE 110 may determine a preferred sensing signal beam pair. The preferred sensing signal beam pair may include a transmitter-side sensing signal beam direction and a corresponding receiver-side sensing signal beam direction. Step 1218 and Step 1220 could be optional, since the beam direction could be obtained not only based on the sensing signal but also based on other approaches, for example, based on channel measurements for initial access and/or channel monitoring after initial access, or based on channel inferring by AI/ML technologies from the historical channel data of the wireless network.

Scanning may operate in one of at least two modes. In a first mode, the scanning is carried out within the range of the TRP transmit SSB beam used in steps 714-1 and 714-2 (collectively, step 1214). In a second mode, the scanning is carried out in a range that extends beyond the range of the TRP transmit SSB beam used in steps 714. The TRP 170 may indicate the mode of scanning as part of the transmission (step 1214) of Msg2.

The UE 110 transmits (step 1222) Msg3 on the PUSCH using uplink resources allocated, to the UE 110, by the TRP 170. Msg3 may carry an RRC Connection Request message or an RRC Connection Re-establishment Request message. An indication of a UE Contention Resolution Identity is also carried by Msg3 for contention resolution. The UE 110 may indicate, as part of the transmission (step 1222) of Msg3, the preferred transmitter-side sensing signal beam direction determined upon receipt (step 1220) of the downlink sensing signals.

The TRP 170 receives (step 1224) the PUCCH and attempts to decode the PUCCH scrambled by the TC-RNTI or a cell RNTI (C-RNTI). If the decoding of PUCCH succeeds, contention resolution and random access are considered to be successful and the TRP 170 allocates a unique C-RNTI to the UE 110.

According to aspects of the present application, the TRP 170 transmits (step 1226), to the UE 110 in the DCI portion of a PDCCH, an indication of a beam direction for a to-be-transmitted PDSCH, expressed in the predefined coordinate system. The indication of the PDSCH beam direction may be represented by differential coordinates. Upon receipt (step 1228) of the DCI, the UE 110 may be considered to have been provided with the physical layer resource allocation that allows the UE 110 to anticipate the scheduled receipt (step 1232) of the to-be-transmitted PDSCH.

Subsequent to transmitting (step 1226) the DCI including the indication of the PDSCH beam direction, the TRP 170 may use the provided PDSCH beam direction to transmit (step 1230) Msg4 to the UE 110. In contrast to the wide SSB beam conventionally used to transmit (step 1030, FIG. 10) Msg4 to the UE 110, aspects of the present application allow the transmission (step 1230) of Msg4 to the UE 110 to occur on the PDSCH channel using a narrow beam.

The TRP 170 may include, in Msg4 in the PDSCH transmitted in step 1230, a UE Contention Identity message to, thereby, complete the contention resolution process. Upon receiving (step 1232), and successfully decoding, Msg4, the UE 110 transmits, to the TRP 170, a HARQ ACK message (not shown).

In known initial access processes, Msg4 can only be transmitted on PDSCH using a wide SSB beam. In contrast, in aspects of the present application, by transmitting a downlink sensing signal, the TRP 170 may sense the location of the UE 110 and, consequently, a preferred narrow sensing beam pair with a suitable connection properties may be obtained. Accordingly, Msg4 can be transmitted (step 1230) on the PDSCH channel using a narrow beam instead of a wide SSB beam. The indication of the narrow beam may be represented by differential coordinates.

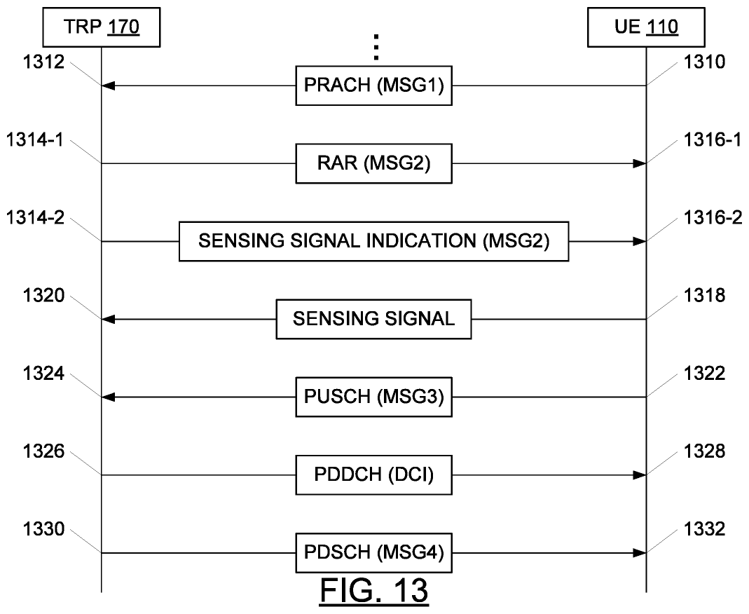

Another alternative to the initial access phase of FIG. 11 is illustrated as a flow diagram in FIG. 13. In common with the initial access phase of FIG. 11, the initial access phase of FIG. 13 relies upon predefinition of a coordinate system. The predefined coordinate system includes multiple local coordinate systems. The TRP 170 is used as the origin in each local coordinate system.

In FIG. 12, a coordinate-based beam indication for describing a to-be-transmitted downlink sensing signal. In contrast, in FIG. 13, a coordinate-based beam indication for describing a to-be-transmitted uplink sensing signal.

In the context of the initial access phase flow diagram of FIG. 13, configuration of one or more sensing signals may be predefined. In the case of a single, predefined sensing signal, such a sensing signal may be called a default sensing signal. Alternatively, in the case wherein there are multiple sensing signals predefined, it will be shown that the TRP 170 receives an indication of one configuration from among the multiple predefined configurations. Each configuration may relate to such sensing signal features as time resource, frequency resource, position, bandwidth, beam direction, beam index, scan mode, beam indication and beam indication manner.

The flow diagram of FIG. 13 begins after the UE 110 has received (step 1108) SIB1.

The UE 110 may initiate random access by transmitting (step 1310), to the TRP 170 using Msg1, a PRACH preamble scrambled using a RA-RNTI.

In aspects of the present application, the UE 110 is to, later, transmit an uplink sensing signal. Accordingly, the UE 110 may transmit, using the Msg1 PRACH preamble, a request that the TRP 170 associate an uplink sensing signal or a group of uplink sensing signals with the UE 110. Upon receiving (step 1312) the PRACH preamble, the TRP 170 may determine a preferred transmit SSB beam index that can provide suitable connectivity.

The TRP 170 may then transmit (step 1314-1) a RAR on the beam corresponding to the preferred transmit SSB beam index. The RAR is also called Msg2.

Since the transmit SSB beam that is preferred by the TRP 170 has been determined, coordinate-based beam indications may begin to be established. The direction of the TRP transmit SSB beam may be used as a reference direction and beam indication may be performed in a coordinate-based differential indication manner. Msg2 may include an indication of the TRP transmit SSB beam as reference transmit beam and the reference direction may be absolute. An absolute reference direction may be expressed in the predefined coordinate system.

The TRP 170 may use Msg2 to transmit (step 1314-2) an indication of a particular to-be-transmitted uplink sensing signal. Conveniently, the to-be-transmitted uplink sensing signal may be configured to be narrower than the TRP transmit SSB beam.

The to-be-transmitted uplink sensing signal may be selected, by the TRP 170, from among predefined sensing signals. The TRP 170 may indicate (step 1314-2), to the UE 110, the selected to-be-transmitted uplink sensing signal by reference to a beam index.

As an alternative to indicating (step 1314-2), to the UE 110, the selected to-be-transmitted uplink sensing signal by reference to a beam index, the TRP 170 may indicate (step 1314-2), to the UE 110, a to-be-transmitted uplink sensing signal using a coordinate-based differential beam indication. The coordinate-based differential beam indication may be based on the reference direction of the TRP transmit SSB beam used to transmit (step 1314-1) Msg2.

As a further alternative to indicating (step 1314-2), to the UE 110, the selected to-be-transmitted uplink sensing signal by reference to a beam index, the TRP 170 may indicate (step 1314-2), to the UE 110, a to-be-transmitted uplink sensing signal using a coordinate-based absolute beam direction indication.

In the foregoing, the to-be-transmitted uplink sensing signal has been referenced as a single signal. Instead, the sensing signal may be a plurality of sensing signals, to be transmitted, by the UE 110 to the TRP 170, in a scanning manner.

Accordingly, when the TRP 170 indicates (step 1314-2), to the UE 110, a to-be-transmitted uplink sensing signal, the TRP 170 may indicate (step 1314-2) a plurality (say, M) of configurations for to-be-transmitted uplink sensing signals.

In one aspect, the TRP 170 may indicate (step 1314-2) all M configurations by beam index or by coordinate, wherein the M is an integer and the M is equal to or larger than 1. In another aspect, the TRP 170 may indicate (step 1314-2) a subset of the M configurations, by beam index or by coordinate, where the subset represents the beam configurations that will not be transmitted. In a further aspect, the TRP 170 may indicate (step 1314-2) an interval or a range using the predefined coordinate system.

During the RAR period window, the UE 110 uses the RA-RNTI to monitor the PDCCH. The UE 110 then receives (steps 816-1 and 816-2) the RAR carried on the PDSCH. The UE 110 may obtain uplink synchronization based on a TA adjustment value found in the RAR message. The UE 110 may also find a TC-RNTI in the RAR message.

Subsequent to the UE 110 having received (step 1316-2) indications of the configuration(s) of the to-be-transmitted uplink sensing signal(s), the UE 110 transmits (step 1318) the uplink sensing signals according to the configurations. To improve sensing precision, the sensing signals may be configured with beams that are narrower than the TRP transmit SSB beam. The TRP 170 may use a scanning approach to the task of receiving (step 1320) the uplink sensing signals. Through such use of the scanning approach, the TRP 170 may determine a preferred sensing signal beam pair. The preferred sensing signal beam pair may include a transmitter-side sensing signal beam direction and a corresponding receiver-side sensing signal beam direction. Step 1318 and Step 1320 could be optional, since the beam direction could be obtained not only based on the sensing signal but also based on other approaches, for example, based on channel measurements for initial access and/or channel monitoring after initial access, or based on channel inferring by AI/ML technologies from the historical channel data of the wireless network.

Scanning may operate in one of at least two modes. In a first mode, the scanning is carried out within the range of the PRACH used in step 1310. In a second mode, the scanning is carried out in a range that extends beyond the range of the PRACH used in step 1310. The TRP 170 may indicate the mode of scanning as part of the transmission (steps 814-1 and 814-2) of Msg2.

The UE 110 transmits (step 1322) Msg3 on the PUSCH using uplink resources allocated, to the UE 110, by the TRP 170. Msg3 may carry an RRC Connection Request message or an RRC Connection Re-establishment Request message. An indication of a UE Contention Resolution Identity is also carried by Msg3 for contention resolution. The UE 110 may also transmit (step 1322), as part of Msg3, an indication of results of the sensing performed on the basis of the sensing signals transmitted in step 1318.

The TRP 170 receives (step 1324) the PUCCH and attempts to decode the PUCCH scrambled by the TC-RNTI or a cell RNTI (C-RNTI). If the decoding of PUCCH succeeds, contention resolution and random access are considered to be successful and the TRP 170 allocates a unique C-RNTI to the UE 110. The TRP 170 may determine, upon receipt (step 1324) of the results of the sensing, a preferred transmitter-side sensing signal beam direction.

According to aspects of the present application, the TRP 170 transmits (step 1326), to the UE 110 in the DCI portion of a PDCCH, an indication of a beam direction for a to-be-transmitted PDSCH, expressed in the predefined coordinate system. The indication of the PDSCH beam direction may be represented by differential coordinates. Upon receipt (step 1328) of the DCI, the UE 110 may be considered to have been provided with the physical layer resource allocation that allows the UE 110 to anticipate the scheduled receipt (step 1332) of the to-be-transmitted PDSCH.

Subsequent to transmitting (step 1326) the DCI including the indication of the PDSCH beam direction, the TRP 170 may use the provided PDSCH beam direction to transmit (step 1330) Msg4 to the UE 110. In contrast to the wide SSB beam conventionally used to transmit (step 1030, FIG. 10) Msg4 to the UE 110, aspects of the present application allow the transmission (step 1330) of Msg4 to the UE 110 to occur on the PDSCH channel using a narrow beam.

The TRP 170 may include, in Msg4 in the PDSCH transmitted in step 1330, a UE Contention Identity message to, thereby, complete the contention resolution process. Upon receiving (step 1332), and successfully decoding, Msg4, the UE 110 transmits, to the TRP 170, a HARQ ACK message (not shown).

In known initial access processes, Msg4 can only be transmitted on PDSCH using a wide SSB beam. In contrast, in aspects of the present application, by transmitting an uplink sensing signal, the UE 110 may sense the location of the TRP 170 and, consequently, a preferred sensing beam pair whose m-dB beamwidth horizontal and/or n-dB beamwidth vertical can be narrower than that of SSB beam with a suitable connection properties may be obtained. m-dB or n-dB beamwidth refers to angle between two directions where the radiated power is m dB or n dB lower than the maximum radiated power, wherein the m or n is a positive real number and the m or n is larger than 0, m can be equal to or not equal to n. Accordingly, Msg4 can be transmitted (step 1330) on the PDSCH channel using a narrow beam instead of a wide SSB beam. The indication of the narrow beam may be represented by differential coordinates.

In aspects of the present application, coordinate-based beam indication may be used for on-demand other system information (OSI) transmission when the UE 110 is in idle/inactive mode. In addition, further aspects of the present application relate to a method for transmitting sensing beams in the proposed OSI transmission system.

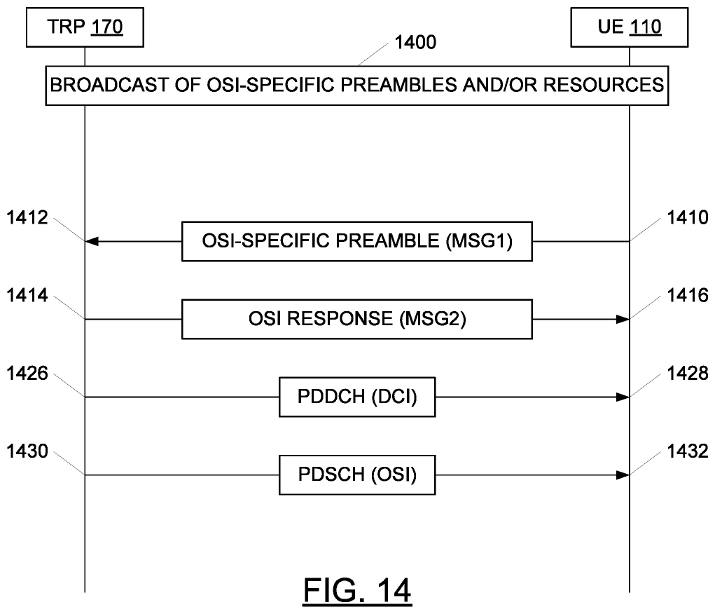

FIG. 14 illustrates, as a signal flow diagram, a Msg1 based OSI request initiated access according to aspects of the present application.

Before access begins, it is understood that a broadcast (step 1400) of OSI-specific preambles and/or resources has occurred.

The UE 110 may initiate random access by transmitting (step 1410), to the TRP 170 using Msg1, an OSI-specific PRACH preamble scrambled using a RA-RNTI. Upon receiving (step 1412) the OSI-specific PRACH preamble, the TRP 170 may determine a preferred transmit SSB beam index that can provide suitable connectivity.

The TRP 170 may then transmit (step 1414) a RAR of OSI (i.e., an OSI response message) on the beam corresponding to the preferred transmit SSB beam index. The OSI response message is also called Msg2.

During the RAR period window, the UE 110 uses the RA-RNTI to monitor the PDCCH. The UE 110 then receives (step 1416) the RAR of OSI carried on the PDSCH. The UE 110 may obtain uplink synchronization based on a TA adjustment value found in the OSI response message. The UE 110 may also find a TC-RNTI in the OSI response message.

Since the transmit SSB beam that is preferred by the TRP 170 has been determined, coordinate-based beam indications may begin to be established. The direction of the TRP transmit SSB beam may be used as a reference direction and beam indication may be performed in a coordinate-based differential indication manner. Msg2 may include an indication of the TRP transmit SSB beam as reference transmit beam and the reference direction may be absolute. An absolute reference direction may be expressed in the predefined coordinate system.

According to aspects of the present application, the TRP 170 transmits (step 1426), to the UE 110 in the DCI portion of a PDCCH, an indication of a beam direction for a to-be-transmitted PDSCH, represented by differential coordinates. Upon receipt (step 1428) of the DCI, the UE 110 may be considered to have been provided with the physical layer resource allocation that allows the UE 110 to anticipate the scheduled receipt (step 1432) of the to-be-transmitted PDSCH.

Subsequent to transmitting (step 1426) of the DCI including the indication of the PDSCH beam direction, the TRP 170 may use the provided PDSCH beam direction to transmit (step 1430) OSI to the UE 110. In contrast to the wide SSB beam conventionally used to transmit (step 1030, FIG. 10) Msg4 to the UE 110, aspects of the present application allow the transmission (step 1430) of OSI to the UE 110 to occur on the PDSCH channel using a narrow beam whose m-dB beamwidth horizontal and/or n-dB beamwidth vertical can be narrower than that of SSB beam with a suitable connection properties may be obtained. m-dB or n-dB beamwidth refers to angle between two directions where the radiated power is m dB or n dB lower than the maximum radiated power, wherein the m or n is a positive real number and the m or n is larger than 0, m can be equal to or not equal to n.

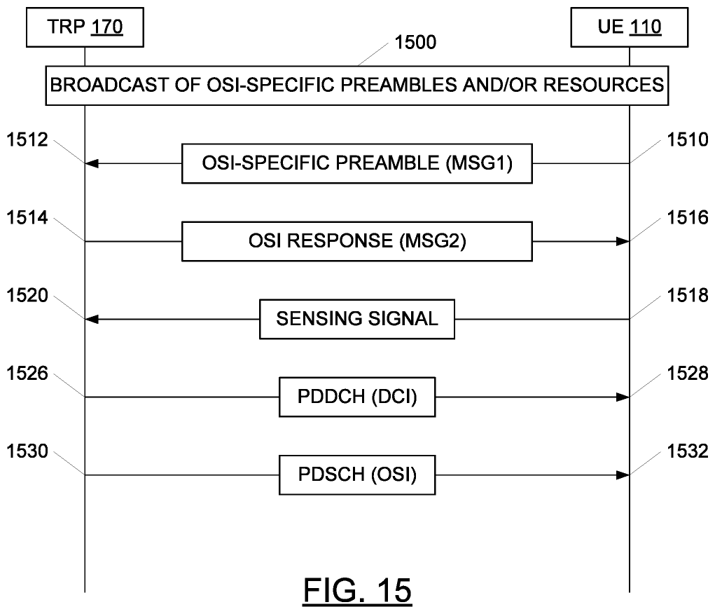

FIG. 15 illustrates, as a signal flow diagram, a Msg1 based OSI request initiated access according to aspects of the present application. Before access begins, it is understood that a broadcast (step 1500) of OSI-specific preambles and/or resources has occurred. The UE 110 may initiate random access by transmitting (step 1510), to the TRP 170 using Msg1, an OSI-specific PRACH preamble scrambled using a RA-RNTI.

In aspects of the present application, the UE 110 is to, later, transmit an uplink sensing signal. Accordingly, the UE 110 may transmit, using the Msg1 PRACH preamble, a request that the TRP 170 associate an uplink sensing signal or a group of uplink sensing signals with the UE 110. Upon receiving (step 1512) the PRACH preamble, the TRP 170 may determine a preferred transmit SSB beam index that can provide suitable connectivity.

The TRP 170 may then transmit (step 1514) a RAR of OSI (i.e., an OSI response message) on the beam corresponding to the preferred transmit SSB beam index. The OSI response message is also called Msg2.

During the RAR period window, the UE 110 uses the RA-RNTI to monitor the PDCCH. The UE 110 then receives (step 1516) the RAR of OSI carried on the PDSCH. The UE 110 may obtain uplink synchronization based on a TA adjustment value found in the OSI response message. The UE 110 may also find a TC-RNTI in the OSI response message.

Since the transmit SSB beam that is preferred by the TRP 170 has been determined, coordinate-based beam indications may begin to be established. The direction of the TRP transmit SSB beam may be used as a reference direction and beam indication may be performed in a coordinate-based differential indication manner. Msg2 may include an indication of the TRP transmit SSB beam as reference transmit beam and the reference direction may be absolute. An absolute reference direction may be expressed in the predefined coordinate system.

The TRP 170 may use Msg2 to transmit (step 1514) an indication of a particular to-be-transmitted uplink sensing signal. Conveniently, the to-be-transmitted uplink sensing signal may be configured to be narrower than the TRP transmit SSB beam.

The to-be-transmitted uplink sensing signal may be selected, by the TRP 170, from among predefined sensing signals. The TRP 170 may indicate (step 1514), to the UE 110, the selected to-be-transmitted uplink sensing signal by signal using a coordinate-based differential beam indication. The coordinate-based differential beam indication may be based on the reference direction of the TRP transmit SSB beam used to transmit (step 1514) Msg2.

In the foregoing, the to-be-transmitted uplink sensing signal has been referenced as a single signal. Instead, the sensing signal may be a plurality of sensing signals, to be transmitted, by the UE 110 to the TRP 170, in a scanning manner.

Accordingly, when the TRP 170 indicates (step 1514), to the UE 110, a to-be-transmitted uplink sensing signal, the TRP 170 may indicate (step 1514) a plurality (say, M) of configurations for to-be-transmitted uplink sensing signals.

Subsequent to the UE 110 having received (step 1516) indications of the configuration(s) of the to-be-transmitted uplink sensing signal(s), the UE 110 transmits (step 1518) the uplink sensing signals according to the configurations. To improve sensing precision, the sensing signals may be configured with beams that are narrower than the TRP transmit SSB beam. The TRP 170 may use a scanning approach to the task of receiving (step 1520) the uplink sensing signals. Through such use of the scanning approach, the UE 110 may determine a preferred sensing signal beam pair. The preferred sensing signal beam pair may include a transmitter-side sensing signal beam direction and a corresponding receiver-side sensing signal beam direction. Step 1518 and Step 1520 could be optional, since the beam direction could be obtained not only based on the sensing signal but also based on other approaches, for example, based on channel measurements for initial access and/or channel monitoring after initial access, or based on channel inferring by AI/ML technologies from the historical channel data of the wireless network.

Scanning may operate in a default mode, wherein the scanning is carried out within the range of the PRACH used in step 1510.

According to aspects of the present application, the TRP 170 transmits (step 1526), to the UE 110 in the DCI portion of a PDCCH, an indication of a beam direction for a to-be-transmitted PDSCH, represented by differential coordinates. Upon receipt (step 1528) of the DCI, the UE 110 may be considered to have been provided with the physical layer resource allocation that allows the UE 110 to anticipate the scheduled receipt (step 1532) of the to-be-transmitted PDSCH.

Subsequent to transmitting (step 1526) of the DCI including the indication of the PDSCH beam direction, the TRP 170 may use the provided PDSCH beam direction to transmit (step 1530) OSI to the UE 110. In contrast to the wide SSB beam conventionally used to transmit (step 1030, FIG. 10) Msg4 to the UE 110, aspects of the present application allow the transmission (step 1530) of OSI to the UE 110 to occur on the PDSCH channel using a narrow beam whose m-dB beamwidth horizontal and/or n-dB beamwidth vertical can be narrower than that of SSB beam with a suitable connection properties may be obtained. m-dB or n-dB beamwidth refers to angle between two directions where the radiated power is m dB or n dB lower than the maximum radiated power, wherein the m or n is a positive real number and the m or n is larger than 0, m can be equal to or not equal to n.

The transmission (step 1518) of sensing signals during on-demand OSI transmission phase may be shown to allow the TRP 170 to start to obtain sensing information of the external environment in the on-demand OSI transmission phase.

In existing on-demand OSI transmission processes, OSI can be transmitted on PDSCH only by using wide SSB beam. In this embodiment, by transmitting sensing signal, UE location may be sensed, and a preferred narrow sensing beam pair with a good connection is obtained. So OSI can be transmitted on the PDSCH channel by using narrow beam instead of wide SSB beam. The indication of the narrow beam is represented by differential coordinates.

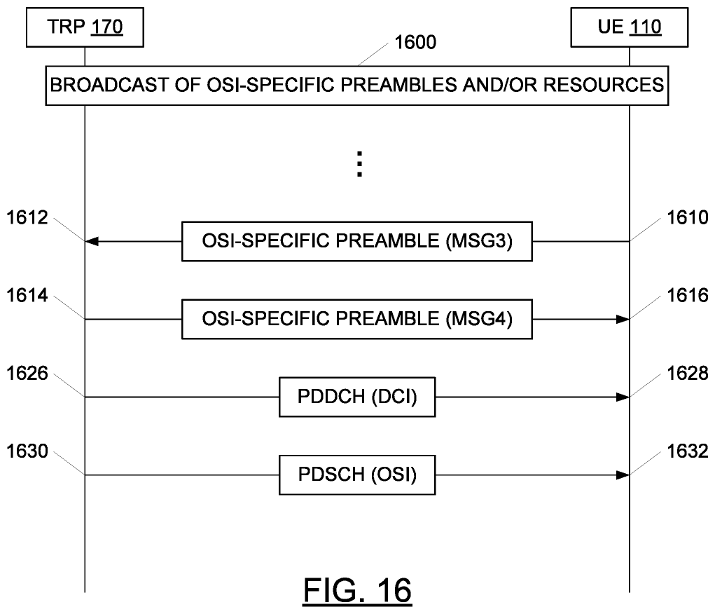

An alternative to the OSI request initiated access of FIG. 14 is illustrated as a flow diagram in FIG. 16. FIG. 16 illustrates, as a signal flow diagram, a Msg3 based OSI request initiated access according to aspects of the present application.

FIG. 16 differs from FIG. 14 in the use of Msg3 to transmit OSI request.

Before access begins, it is understood that a broadcast (step 1600) of OSI-specific preambles and/or resources has occurred.

The flow diagram of FIG. 16 begins after the UE 110 transmits (step 1610), to the TRP 170 using Msg3, an OSI-specific preamble. In particular, the UE 110 may initiate random access by transmitting (step 1610), to the TRP 170 using Msg3, an OSI-specific PRACH preamble scrambled using a RA-RNTI. Upon receiving (step 1612) the OSI-specific PRACH preamble, the TRP 170 may determine a preferred transmit SSB beam index that can provide suitable connectivity.

The TRP 170 may then transmit (step 1614) a RAR of OSI (i.e., an OSI response message) on the beam corresponding to the preferred transmit SSB beam index. The OSI response message is also called Msg4.

During the RAR period window, the UE 110 uses the RA-RNTI to monitor the PDCCH. The UE 110 then receives (step 1616) the RAR of OSI carried on the PDSCH. The UE 110 may obtain uplink synchronization based on a TA adjustment value found in the OSI response message. The UE 110 may also find a TC-RNTI in the OSI response message.

Since the transmit SSB beam that is preferred by the TRP 170 has been determined, coordinate-based beam indications may begin to be established. The direction of the TRP transmit SSB beam may be used as a reference direction and beam indication may be performed in a coordinate-based differential indication manner. Msg4 may include an indication of the TRP transmit SSB beam as reference transmit beam and the reference direction may be absolute. An absolute reference direction may be expressed in the predefined coordinate system.

According to aspects of the present application, the TRP 170 transmits (step 1626), to the UE 110 in the DCI portion of a PDCCH, an indication of a beam direction for a to-be-transmitted PDSCH, represented by differential coordinates. Upon receipt (step 1628) of the DCI, the UE 110 may be considered to have been provided with the physical layer resource allocation that allows the UE 110 to anticipate the scheduled receipt (step 1632) of the to-be-transmitted PDSCH.

Subsequent to transmitting (step 1626) of the DCI including the indication of the PDSCH beam direction, the TRP 170 may use the provided PDSCH beam direction to transmit (step 1630) OSI to the UE 110. In contrast to the wide SSB beam conventionally used to transmit (step 1030, FIG. 10) Msg4 to the UE 110, aspects of the present application allow the transmission (step 1630) of OSI to the UE 110 to occur on the PDSCH channel using a narrow beam whose m-dB beamwidth horizontal and/or n-dB beamwidth vertical can be narrower than that of SSB beam with a suitable connection properties may be obtained. m-dB or n-dB beamwidth refers to angle between two directions where the radiated power is m dB or n dB lower than the maximum radiated power, wherein the m or n is a positive real number and the m or n is larger than 0, m can be equal to or not equal to n.

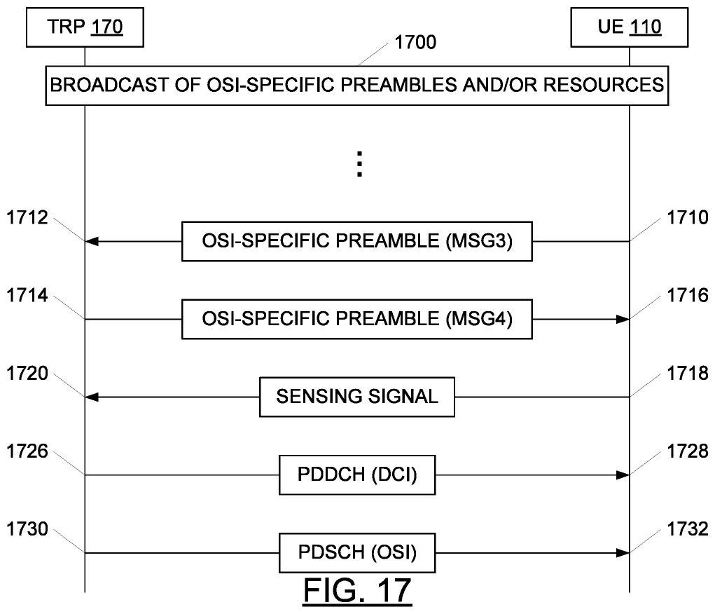

An alternative to the OSI request initiated access of FIG. 16 is illustrated as a flow diagram in FIG. 17. FIG. 17 illustrates, as a signal flow diagram, a Msg3-based OSI request initiated access according to aspects of the present application.

FIG. 17 differs from FIG. 15 in the use of Msg3 to transmit OSI request.

Before access begins, it is understood that a broadcast (step 1700) of OSI-specific preambles and/or resources has occurred.

The flow diagram of FIG. 17 begins after the UE 110 transmits (step 1710), to the TRP 170 using Msg3, an OSI-specific PRACH preamble. In particular, the UE 110 may initiate random access by transmitting (step 1710), to the TRP 170 using Msg3, an OSI-specific PRACH preamble scrambled using a RA-RNTI.

In aspects of the present application, the UE 110 is to, later, transmit an uplink sensing signal. Accordingly, the UE 110 may transmit, using the Msg3 PRACH preamble, a request that the TRP 170 associate an uplink sensing signal or a group of uplink sensing signals with the UE 110. Upon receiving (step 1712) the PRACH preamble, the TRP 170 may determine a preferred transmit SSB beam index that can provide suitable connectivity.

The TRP 170 may then transmit (step 1714) a RAR of OSI (i.e., an OSI response message) on the beam corresponding to the preferred transmit SSB beam index. The OSI response message is also called Msg4.

During the RAR period window, the UE 110 uses the RA-RNTI to monitor the PDCCH. The UE 110 then receives (step 1716) the RAR of OSI carried on the PDSCH. The UE 110 may obtain uplink synchronization based on a TA adjustment value found in the OSI response message. The UE 110 may also find a TC-RNTI in the OSI response message.

Since the transmit SSB beam that is preferred by the TRP 170 has been determined, coordinate-based beam indications may begin to be established. The direction of the TRP transmit SSB beam may be used as a reference direction and beam indication may be performed in a coordinate-based differential indication manner. Msg2 may include an indication of the TRP transmit SSB beam as reference transmit beam and the reference direction may be absolute. An absolute reference direction may be expressed in the predefined coordinate system.

The TRP 170 may use Msg4 to transmit (step 1714) an indication of a particular to-be-transmitted uplink sensing signal. Conveniently, the to-be-transmitted uplink sensing signal may be configured to be narrower than the TRP transmit SSB beam.

The to-be-transmitted uplink sensing signal may be selected, by the TRP 170, from among predefined sensing signals. The TRP 170 may indicate (step 1714), to the UE 110, the selected to-be-transmitted uplink sensing signal by signal using a coordinate-based differential beam indication. The coordinate-based differential beam indication may be based on the reference direction of the TRP transmit SSB beam used to transmit (step 1714) Msg4.

In the foregoing, the to-be-transmitted uplink sensing signal has been referenced as a single signal. Instead, the sensing signal may be a plurality of sensing signals, to be transmitted, by the UE 110 to the TRP 170, in a scanning manner.

Accordingly, when the TRP 170 indicates (step 1714), to the UE 110, a to-be-transmitted uplink sensing signal, the TRP 170 may indicate (step 1714) a plurality (say, M) of configurations for to-be-transmitted uplink sensing signals.

Subsequent to the UE 110 having received (step 1716) indications of the configuration(s) of the to-be-transmitted uplink sensing signal(s), the UE 110 transmits (step 1718) the uplink sensing signals according to the configurations. To improve sensing precision, the sensing signals may be configured with beams that are narrower than the TRP transmit SSB beam. The TRP 170 may use a scanning approach to the task of receiving (step 1720) the uplink sensing signals. Through such use of the scanning approach, the UE 110 may determine a preferred sensing signal beam pair. The preferred sensing signal beam pair may include a transmitter-side sensing signal beam direction and a corresponding receiver-side sensing signal beam direction.

Scanning may operate in a default mode, wherein the scanning is carried out within the range of the PRACH used in step 1710.

According to aspects of the present application, the TRP 170 transmits (step 1726), to the UE 110 in the DCI portion of a PDCCH, an indication of a beam direction for a to-be-transmitted PDSCH, represented by differential coordinates. Upon receipt (step 1728) of the DCI, the UE 110 may be considered to have been provided with the physical layer resource allocation that allows the UE 110 to anticipate the scheduled receipt (step 1732) of the to-be-transmitted PDSCH.

Subsequent to transmitting (step 1726) of the DCI including the indication of the PDSCH beam direction, the TRP 170 may use the provided PDSCH beam direction to transmit (step 1730) OSI to the UE 110. In contrast to the wide SSB beam conventionally used to transmit (step 1030, FIG. 10) Msg4 to the UE 110, aspects of the present application allow the transmission (step 1730) of OSI to the UE 110 to occur on the PDSCH channel using a narrow beam whose m-dB beamwidth horizontal and/or n-dB beamwidth vertical can be narrower than that of SSB beam with a suitable connection properties may be obtained. m-dB or n-dB beamwidth refers to angle between two directions where the radiated power is m dB or n dB lower than the maximum radiated power, wherein the m or n is a positive real number and the m or n is larger than 0, m can be equal to or not equal to n.

The transmission (step 1718) of sensing signals during on-demand OSI transmission phase may be shown to allow the TRP 170 to start to obtain sensing information of the external environment in the on-demand OSI transmission phase.

In existing on-demand OSI transmission processes, OSI can be transmitted on PDSCH only by using wide SSB beam. In this embodiment, by transmitting sensing signal, UE location may be sensed, and a preferred narrow sensing beam pair with a good connection is obtained. So OSI can be transmitted on the PDSCH channel by using narrow beam instead of wide SSB beam. The indication of the narrow beam is represented by differential coordinates.

Aspects of the present application relate to Discontinuous Reception (DRX). In known communication schemes, without DRX, the UE has to be awake all the time to receive and decode downlink data, as the data in the downlink may arrive at any time. Accordingly, the UE monitors the PDCCH in every subframe to determine whether downlink data is available. This monitoring consumes UE power. DRX has been introduced to improve UE battery lifetime. When DRX is employed, the UE discontinuously receives downlink data on the PDCCH.

A DRX cycle may be configured for the UE. In the DRX cycle, the UE spends some of the DRX cycle in a “DRX Active state” and the rest of the DRX cycle in a “DRX Sleep state.” In the DRX Active state, the UE listens for downlink data. In the DRX Sleep state, the UE powers down most of its circuitry.

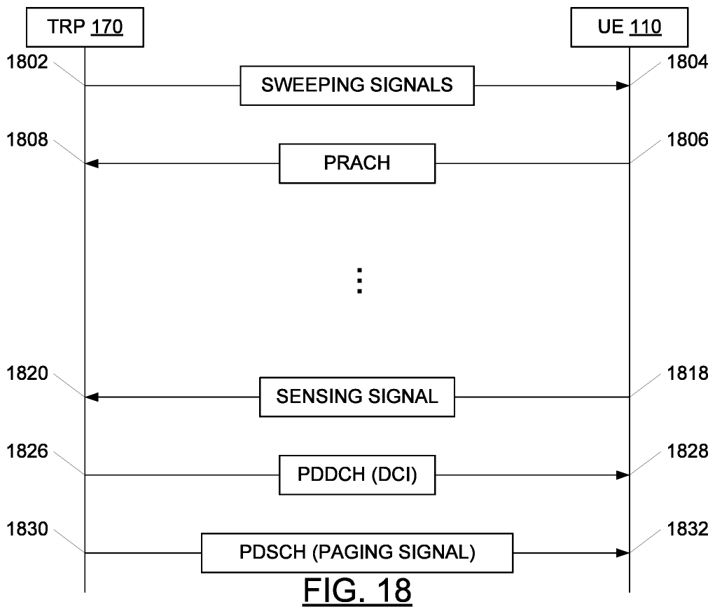

“Paging” is a known process in which a TRP 170 searches for a specific UE 110. FIG. 18 illustrates, in a signal flow diagram, a paging process in accordance with aspects of the present application. In contrast to known paging processes, the signal flow diagram of FIG. 18 relates to a paging process that includes coordinate-based beam indication scheme and transmission of an uplink sensing signal.

The sensing beam for the uplink sensing signal may be preconfigured in signaling that has, in the past, allowed the UE 110 to be in an RRC_CONNECTED state. The preconfiguring of the sensing beam may specify features such as time-frequency resource position, bandwidth, beam direction, beam index, scan mode, beam indication, beam indication manner, etc.

Initially, the TRP 170 uses SSB beams to transmit (step 1802) signals in a sweeping mode. According to the DRX cycle, the UE 110 periodically enters the DRX Active state and executes a sweeping approach in an attempt to receive a signal. By using this sweeping approach, the UE 110 may determine a preferred SSB receive beam. The UE 110 may then receive (step 1804) signals on the preferred SSB receive beam.

The UE 110 then transmits (step 1806), using the PRACH on a beam configured in the same manner that the sensing beam has been preconfigured, an indication of the preferred SSB receive beam. Indeed, the UE 110 may use a PRACH preamble scrambled using a RA-RNTI. Upon receiving (step 1808) the PRACH preamble, the TRP 170 may determine a preferred transmit SSB beam that can provide suitable connectivity.

The UE 110 may, subsequently, proceed through the DRX cycle repeatedly. At one point, upon entering the DRX Active state, the UE 110 may transmit (step 1818) an uplink sensing signal. The beam direction of the sensing signals may be associated with the beam direction of the preferred SSB receive beam. Other features of the sensing signal may be set according to the manner in which the uplink sensing signal has been preconfigured.

To improve sensing precision, the sensing signals may be configured with beams that are narrower than the TRP transmit SSB beam. The TRP 170 may use a scanning approach to the task of receiving (step 1820) the uplink sensing signals. Through such use of the scanning approach, the TRP 170 may determine a preferred sensing signal beam pair. The preferred sensing signal beam pair may include a transmitter-side sensing signal beam direction and a corresponding receiver-side sensing signal beam direction.

According to aspects of the present application, the TRP 170 transmits (step 1826), to the UE 110 in the DCI portion of a PDCCH, an indication of a beam direction for a to-be-transmitted PDSCH, expressed in the predefined coordinate system. The indication of the PDSCH beam direction may be represented by differential coordinates. Upon receipt (step 1828) of the DCI, the UE 110 may be considered to have been provided with the physical layer resource allocation that allows the UE 110 to anticipate the scheduled receipt (step 1832) of the to-be-transmitted PDSCH.

Subsequent to transmitting (step 1826) the DCI including the indication of the PDSCH beam direction, the TRP 170 may use the provided PDSCH beam direction to transmit (step 1830) a paging message to the UE 110. In contrast to the wide SSB beam conventionally used to transmit paging messages to the UE 110, aspects of the present application allow the transmission (step 1830) of a paging message to the UE 110 to occur on the PDSCH channel using a narrow beam whose m-dB beamwidth horizontal and/or n-dB beamwidth vertical can be narrower than that of SSB beam with a suitable connection properties may be obtained. m-dB or n-dB beamwidth refers to angle between two directions where the radiated power is m dB or n dB lower than the maximum radiated power, wherein the m or n is a positive real number and the m or n is larger than 0, m can be equal to or not equal to n.

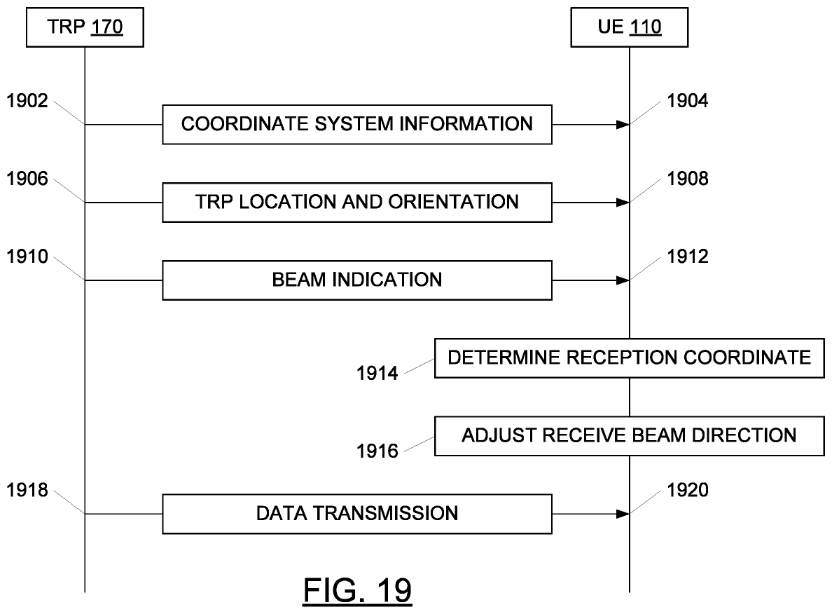

FIG. 19 illustrates, in a signal flow diagram, a data transmission process in accordance with aspects of the present application.

It has been mentioned hereinbefore that a network-wide coordinate system may be defined. The coordinate network-wide system may include a global coordinate system and multiple local coordinate systems. A Global Coordinate System (GCS) is defined for a system comprising of multiple TRPs 170 and UEs 110. An antenna array for a TRP 170 or a UE 110 can be defined in a Local Coordinate System (LCS).

As an initial step in the signal flow diagram of FIG. 19, the TRP 170 transmits (step 1902), to the UE 110, information describing the network-wide coordinate system and the local coordinate system. This transmission (step 1902) may, for example, use known radio resource control (RRC) signaling. The coordinate system information is received (step 1904) at the UE 110.

Subsequently, the TRP 170 transmits (step 1906) location coordinates for the TRP 170 and an indication of the orientation of the TRP 170. This transmission (step 1906) may, for example, use known RRC signaling. The location and orientation information is received (step 1908) at the UE 110.

Furthermore, the TRP 170 transmits (step 1910), to the UE 110, an indication of the transmit beam of the PDSCH/PDCCH, CSI-RS, TRS, PRS, PTRS and/or the receive beam of the PUSCH/PUCCH, SRS, PTRS. The TRP 170 may indicate the transmit beam using a transmission coordinate, ξ₁. The transmission coordinate, ξ₁, may be obtained, by the TRP 170, using sensing. This transmission (step 1910) may, for example, use known RRC signaling. The beam indication is received (step 1912) at the UE 110.

A UE reference receive beam may be described using coordinates, (α₁, α₂). The UE 110 may be considered to have a goal of adjusting the direction of the receive beam to align with the transmit beam. Indeed, the direction of the receive beam may be adjusted to a reception coordinate, ξ₂. A representative formula for determining the reception coordinate, ξ₂, is as follows:

ξ₂=f(α₁,α₂,ξ₁)

In operation, upon receiving (step 1912) the beam indication, the UE 110 may use the formula to determine (step 1914) the reception coordinate, ξ₂. The UE 110 may then adjust (step 1916) the receive beam direction.

Consequently, when the TRP 170 transmits (step 1918) data on the transmit beam with the transmit beam direction, the UE 110 may receive (step 1920) the data using a receive beam with a receive beam direction that appropriately optimizes reception.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method, comprising:
broadcasting coordinate information of a transmit receive point, the coordinate information relative to a predefined coordinate system; and
transmitting, to a user equipment, an indication of a beam direction of a physical channel, the indication employing the predefined coordinate system.

2. The method of claim 1, wherein the beam direction comprises a value representative of a zenith of an angle of arrival, a value representative of a zenith of an angle of departure, a value representative of an azimuth of an angle of arrival, or an azimuth of an angle of departure.

3. The method of claim 1, further comprising broadcasting the predefined coordinate system.

4. The method of claim 1, wherein the physical channel comprises a physical downlink control channel, a physical downlink shared channel, a physical uplink shared channel, a physical uplink control channel, an uplink pilot, a downlink pilot, an uplink reference signal, a downlink reference signal, an uplink measurement channel, or a downlink measurement channel.

5. The method of claim 1, wherein the beam direction comprises differential coordinates relative to a reference beam direction.

6. The method of claim 5, wherein the reference beam direction comprises coordinates of a synchronization signal block beam direction, or coordinates of a sensing beam direction.

7. The method of claim 1, wherein the broadcasting the coordinate information of the transmit receive point further comprises transmitting a system information block.

8. The method of claim 1, further comprising transmitting the physical channel using the beam direction.

9. A method comprising:
receiving coordinate information of a transmit receive point, the coordinate information relative to a predefined coordinate system; and
receiving an indication of a beam direction of a physical channel, the indication employing the predefined coordinate system.

10. The method of claim 9, wherein the beam direction comprises a value representative of a zenith of an angle of arrival, a value representative of a zenith of an angle of departure, a value representative of an azimuth of an angle of arrival, or an azimuth of an angle of departure.

11. The method of claim 9, wherein the physical channel comprises a physical downlink control channel, a physical downlink shared channel, a physical uplink shared channel, a physical uplink control channel, an uplink pilot, a downlink pilot, an uplink reference signal, a downlink reference signal, an uplink measurement channel, or a downlink measurement channel.

12. The method of claim 9, wherein the beam direction comprises differential coordinates relative to a reference beam direction.

13. The method of claim 12, wherein the reference beam direction comprises coordinates of a synchronization signal block beam direction, or coordinates of a sensing beam direction.

14. An apparatus comprising:
a memory storing instructions; and
a processor configured, by executing the instructions, to:
broadcast coordinate information of the transmit receive point, the coordinate information relative to a predefined coordinate system; and
transmit an indication of a beam direction of a physical channel, the indication employing the predefined coordinate system.

15. The apparatus of claim 14, wherein the beam direction comprises a value representative of a zenith of an angle of arrival, a value representative of a zenith of an angle of departure, a value representative of an azimuth of an angle of arrival, or an azimuth of an angle of departure.

16. The apparatus of claim 14, wherein the processor further configured, by executing the instructions, to broadcast the predefined coordinate system.

17. The apparatus of claim 14, wherein the physical channel comprises a physical downlink control channel, a physical downlink shared channel, a physical uplink shared channel, a physical uplink control channel, an uplink pilot, a downlink pilot, an uplink reference signal, a downlink reference signal, an uplink measurement channel, or a downlink measurement channel.

18. The apparatus of claim 14, wherein the beam direction comprises differential coordinates relative to a reference beam direction.

19. An apparatus comprising:
a memory storing instructions; and
a processor configured, by executing the instructions, to:
receive coordinate information of a transmit receive point, the coordinate information relative to a predefined coordinate system; and
receive an indication of a beam direction of a physical channel, the indication employing the predefined coordinate system.

20. The method of claim 19, wherein the beam direction comprises a value representative of a zenith of an angle of arrival, a value representative of a zenith of an angle of departure, a value representative of an azimuth of an angle of arrival, or an azimuth of an angle of departure.
